(19) United States
(12) Patent Application Publication
(10) Pub. No.: US 2007/0178865 A1
(43) Pub. Date: Aug. 2, 2007

(54) Content Depot

(76) Inventors: Ryan S. Steelberg, Irvine, CA (US); Chad E. Steelberg, Newport Beach, CA (US); Russell K. Ketchum, Newport Beach, CA (US); William Irvin, Laguna Beach, CA (US)

Correspondence Address: FISH & RICHARDSON P.C., PO BOX 1022, MINNEAPOLIS, MN, 55440-1022, US

(21) Appl. No.: 11/611,634

(22) Filed: Dec. 15, 2006

Related U.S. Application Data
(60) Provisional application No. 60/751,348, filed on Dec. 15, 2005.

(51) Int. Cl. H04H 1/00; H04B 1/18

(52) U.S. Cl. 455/186.1; 455/151.1; 455/3.01

(57) ABSTRACT

A system and method for delivery and management of live and pre-produced broadcasts is disclosed. Programming can be distributed in real time over a delivery medium (e.g., satellite). Stations can streamline program management using a depot. The depot may centralize storage and program retrieval. The depot can be of the form of a distributed content storage and management system. Alternatively, the depot may be located at a hub that can be used to capture and manage all broadcast content and associated data and meta-data which are non-radio content.

### BACKGROUND

Media delivery systems can be used to deliver content to users. One such example of a media delivery system includes a radio broadcast station. A conventional radio broadcast station can present a combination of live and pre-recorded content to listeners. A radio broadcast station can also include an automation system that allows for the delivery of program content (referred to herein as “content”) and traffic (e.g., advertising) automatically to the listening audience. The automation system can play a program that is developed by, for example, the station. The program includes a schedule log or playlist that defines the content and traffic (the sum total of which is referred to herein as “radio content”) that is to be broadcast. The playlist can be developed locally, at the radio broadcast station, or remotely then delivered to the radio broadcast station along with the appropriate content.

### SUMMARY

In some implementations, a method includes: centrally storing content for distribution to one or more radio stations; receiving a request for a content item from a requesting radio station; evaluating the request to determine if the requesting radio station is authorized to receive the content item; and if so, providing the content item including converting one or more headers associated with the content item based on data associated with the requesting radio station.

In some implementations, a method includes: identifying content from plural sources for publication by one or more radio stations; aggregating the identified content in a central repository; controlling access to the aggregated content; receiving requests to access the identified content; identifying transfer controls associated with the publication of the accessed content; and transferring, in accordance with the transfer controls, content associated with requests upon verification of credentials associated with a requesting device.

In some implementations, a method includes: aggregating content; marketing the content for distribution to one or more radio stations; receiving a selection of a content item; pre-processing the selected item in accordance with system parameters associated with a requesting system; and delivering the pre-processed item to the requesting system.

In some implementations, an apparatus includes a hub including a content depot, the content depot including designators for one or more content items that are available to authorized radio stations for play on the radio station. An interface is communicatively coupled between the content depot and one or more radio stations. The user interface is for managing content in the content depot including the inclusion of content in the depot by content providers, and the selection of content by a radio station for inclusion in a playlist associated with the radio station. A conversion engine is operable to convert a content item or metadata associated with a content item in accordance with parameters associated with a requesting radio station wherein at least one parameter is an automation system type of a requesting radio station.

Particular embodiments of the subject matter described in this specification can be implemented to realize none, one or more of the following advantages.

Services can be provided that are real time or subscription based. A system and methods for delivery and management of live and pre-produced broadcasts can be provided. Programming can be distributed in real time over a delivery medium (e.g., satellite). Stations can streamline program management using a depot. The depot may centralize storage and program retrieval. The depot can be of the form of a distributed content storage and management system. Alternatively, the depot may be located at a hub that can be used to capture and manage all broadcast content and associated data and meta-data which are non-radio content.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an exemplary communication system architecture.

FIG. 2 is an exemplary structure for the partitioning of content within the content depot.

FIG. 3 is a an exemplary method for requesting content.

FIG. 4a is an exemplary method for configuring content transfers.

FIG. 4b is an exemplary user interface for the specification of configuration information for content transfers for a radio station in concert with a Maestro digital automation system.

FIG. 4c is an exemplary user interface for the specification of configuration information for content transfers for a radio station in concert with an SS32 digital automation system.

FIG. 5 is an exemplary method for managing content that is included in the content depot.

FIG. 6 is an exemplary process for distributing content.

FIG. 7 is an exemplary process for distributing content.

Like reference symbols in the various drawings indicate like elements.

### DETAILED DESCRIPTION

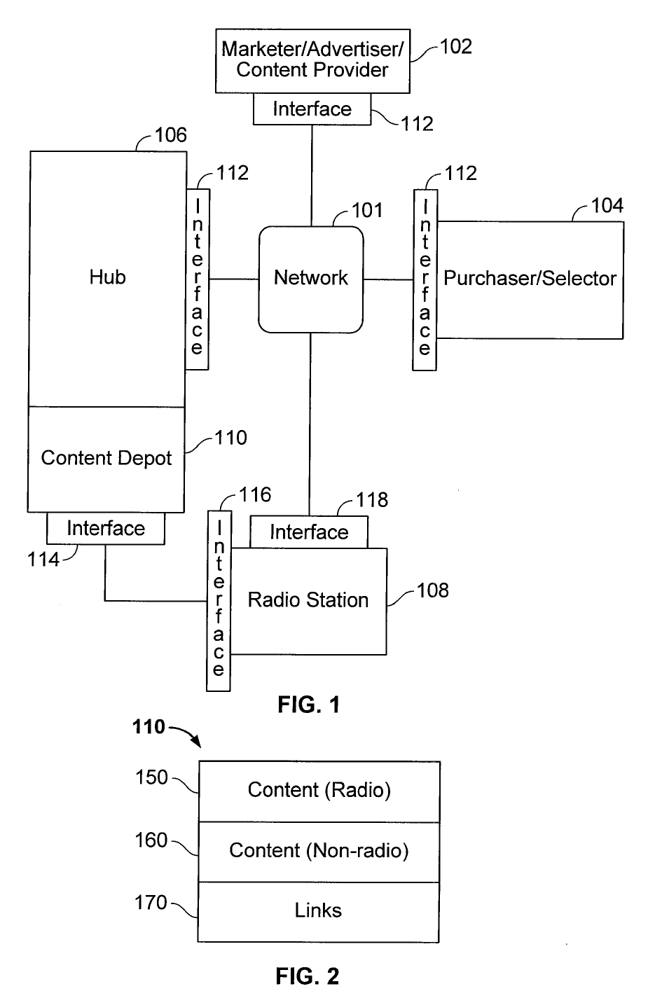

An exemplary architecture of a communication system 100 is shown in FIG. 1. System 100 may include a networked environment (including network 101) for communicatively coupling one or more marketers 102, content selectors (e.g., purchaser 104), a hub 106 and a radio station 108.

The hub 106 can be used to capture and manage all broadcast content (e.g., radio content) and associated data and metadata which are non-radio content. The hub 106 can include a content depot 110. The content depot 110 can serve as a storage location at the hub 106 for, for example, live streams and pre-recorded data. Programming can be accessed when needed by a station, such as radio station 108, from the hub 106. More particularly, the content depot 110 can be used to provide (e.g., stream or otherwise download) the stored content to a requesting station, e.g., radio station 108. The provisioning of the stored content can be in accordance with non-radio content (e.g., the metadata stored at the content depot 110 that defines parameters for transferring content to the requesting station). Though shown as integrated, the content depot 110 can be separate from the hub 106. Further, elements of the hub 106 can be distributed.

The marketer 102 and the selector/purchaser 104 can access the content depot 110 through an interface, for example, a web portal 112 using the network 101. Examples of interfaces are discussed in greater detail below. The marketer 102 can be a marketer of content or traffic (e.g., advertisements) or both. The marketer 102 can be a producer of content (e.g., a syndicated broadcast program producer), a distributor of content, or re-distributor. Marketers 102 may market their information using content depot 110. More specifically, the content depot 110 may store the information being marketed, and upon selection (e.g., purchase), the marketed information can be made accessible to the selector (e.g., purchaser), such as by granting permission to the selector/purchaser to access the selected/purchased information from the content depot 110. Such accessibility may be granted for example, through web portal 112. Web portal access is discussed in greater detail below. The purchaser 104 may be a radio station. The purchaser 104 can be the purchaser of content, traffic or both. Though reference is made to a purchase, other transactions are possible.

As described above, system 100 includes a content depot 110 for storing, receiving, and transferring content and/or traffic. Referring now to FIG. 2, the content depot 110 can store radio 150 and/or non-radio content 160. An example of radio content 150 is a radio broadcast, being either a live stream or a pre-recorder program received from, for example, satellite, the Internet, or an intranet; examples of non-radio content 160 include metadata and data associated with radio content. In some implementations, the content depot 110 may include non-radio content in the form of one or more links 170 which, when accessed, lead to associated radio content. In another example, metadata may allow a user to access radio content linked as a series, an individual episode of a series, a partial play (a “snippet”), an explanation, and the like.

Referring again to FIG. 1, radio station 108 can include one or more interfaces 114 and a radio automation system 120 (i.e., RAS). The interfaces 114 can be used to communicate with the content depot 110. In the implementation shown, the interfaces 114 include a communications port (i.e., COM port 116) and network interface 118 (e.g., a web portal). Other interfaces are possible. In some implementations, the radio station 108 can access and retrieve information from the content depot 110 using the web portal. In some implementations, the content depot 110 may transfer content to a requesting radio station by streaming it or by uploading it. The streaming and uploading may be performed, for example, via an internet protocol (“IP”) over satellite. For example, streamed content may simply “pass through” the content depot 110 (from a marketer 102 or other provider), and be streamed by the hub 106 to a requesting radio station 108. In another example, radio content may be transferred from the content depot 110 to a requesting radio station(s) 108 as files, rather than streams. In some implementations, the transfer of radio content from the content depot 110 to a requesting station can be in accordance with non-radio content that is specified either by the system, the user or both and stored at the content depot 110.

By way of example a number of methods for providing, marketing, requesting, and accessing content, controlling content transfer and the like are discussed below. The examples are made with reference to the architecture shown in FIG. 1, though the methods can be executed on other systems configured in accordance with other architectures.

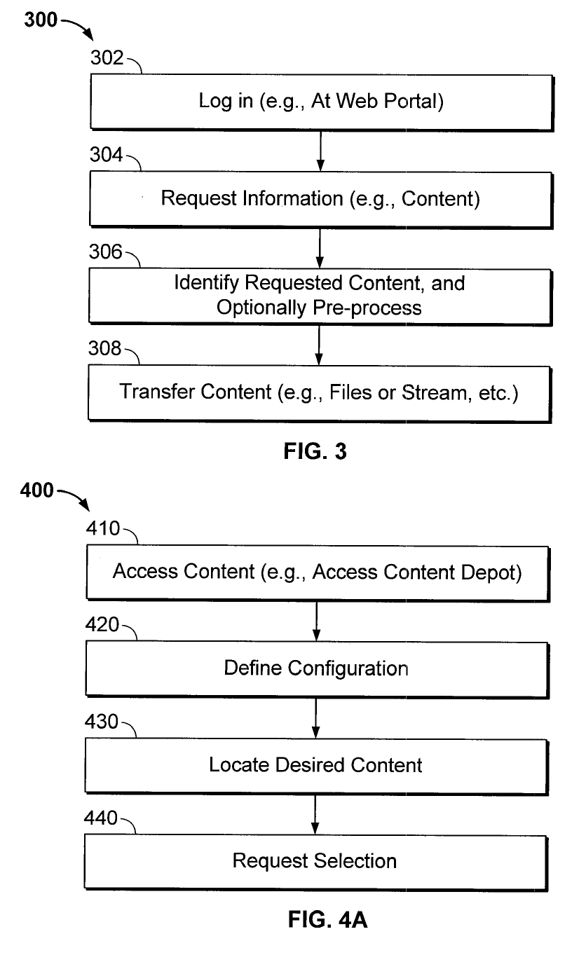

Referring to FIG. 3, a method 300 for requesting content (e.g., from the content depot 110) is shown. The method 300 begins with a user accessing (302) the content depot by for example, logging in through a web portal 112. In some implementations, the user will provide information—for example a user name and a password—to the web portal. Using the information provided, the web portal may grant or deny access to the user.

The user then typically requests (304) content from the content depot, including radio and non-radio content. The content depot may then identify (306) the requested content and may perform some pre-transfer processing (not shown). In some implementations, the pre-transfer processing includes modifying (e.g., by the content depot 110) the content for transfer. For example, the content depot may modify content in the form of a stream by converting it into the form of a single file. Other pre-processing can include header conversions, path construction, and saving a content item as a file of a particular type in a path specified by the requesting system. For example, if the automation system type of the requesting station is SS32, then pre-processing the content item can include converting a cart header associated with the content item to a SS32 type cart header. Further, pre-processing can include calculating a duration of audio associated with the content item and updating the content item header. In some implementations, pre-processing includes receiving a path definition that includes a digital system audio path, cart number and a category, constructing a path using the digital audio path and the category, and saving a file associated with the content item in the path with the cart number specified. In some implementations, if the automation system is Maestro, then pre-processing the content item includes converting a cart header associated with the content item to a DAF type cart header. In some implementations, pre-processing includes receiving a path definition that includes a digital system audio path and cart number, and saving a file associated with the content item in the digital audio system path with the cart number specified. Other processing steps are possible.

After having identified the requested content and possibly performed some pre-transfer processing, the requested content can be transferred (308). The transfer can be controlled by non-radio content that is specified by the user or the system or a combination of both. In some implementations, the content is transferred using an interface that connects the content depot 110 with existing equipment (e.g., a radio automation system 120) at the destination of the content. For example, a COM port 116, e.g., a satellite interface, may be used to connect the content depot 110 and a requesting radio station 108. In some implementations, the interface may always be used (e.g., a continuous connection); in other implementations the interface may only be used when requested by a radio station.

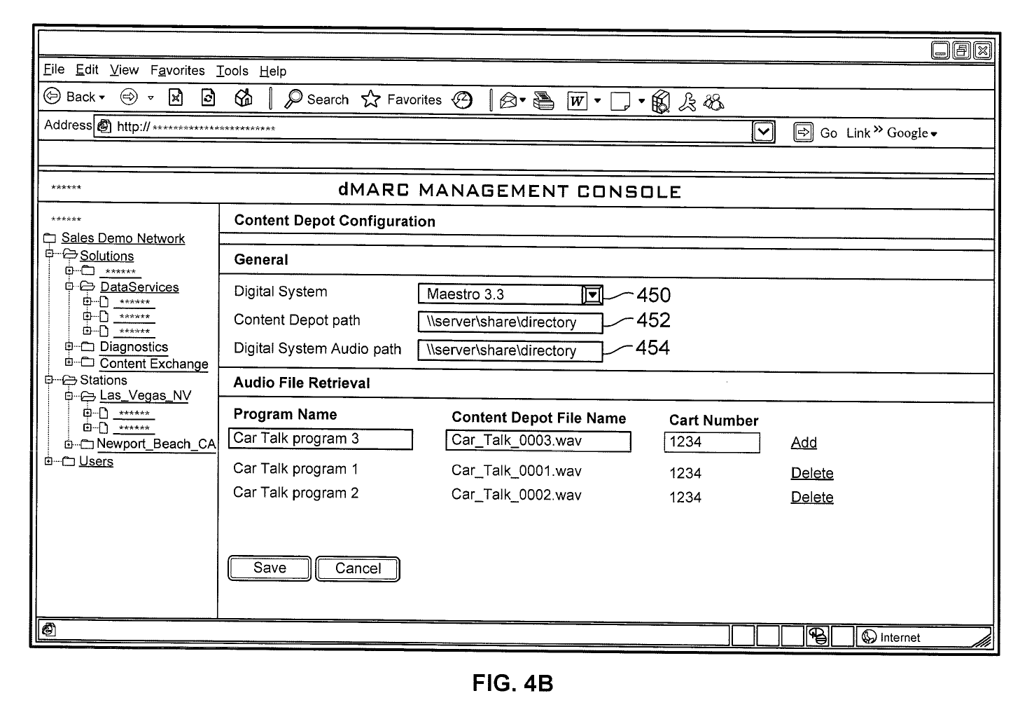

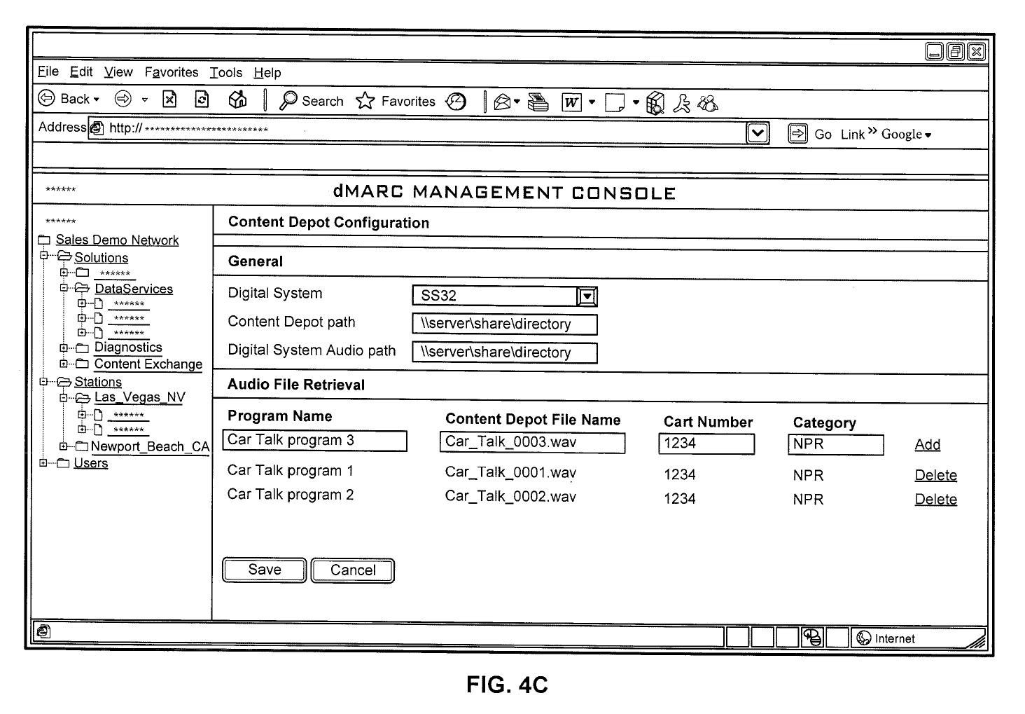

Referring now to FIG. 4a, a method 400 for configuring content transfers is shown. The method is described by way of example with reference to a user. In one implementation, the user includes a radio station. The user may access the content depot similarly as discussed above (410).

Upon accessing the content depot, the user may define a requesting station configuration (420). For example, the user may define a configuration by creating or modifying a user profile or a user account. In some implementations, each user may uniquely configure the content depot via a web portal. For example, each radio station may configure the following in a profile: the network path to use for transferring the content to the radio station; the method of handling the content after a transfer, with or without instructions; a choice of file names, cart numbers, or play-categories (such as for a SS32 automation system or a Maestro automation system); and streaming or file transfer options (e.g., transfer as a file or stream the content). Accordingly, the content depot 110 can be uniquely configurable for each user. Based on requesting station information such as automation system information (maintained as part of the configuration information/preferences associated with a user account or from non-radio information provided as part of a request for content), all necessary conversions of requested data, such as header conversions can be provided to allow for the correct placement of the selected content in a desired slot at the requesting station (i.e., into the automation system of the requesting station).

In some implementations, the content depot may use the defined configuration information in a profile to produce alerts to users. For example, the content depot may produce an alert to a user upon receipt of new information, or upon receipt of changes to a profile. Referring to FIGS. 4b-c, an exemplary user interface presented as part of, for example, a web portal is shown. The user interface shown in FIG. 4b allows the user to specify configuration information associated with a requesting station including digital automation system 450 (e.g., Maestro 3.3), depot path definition 452 (for a content item), and digital system audio path 454 (path for where item is to be placed in the requesting automation system). The user interface also allows a user to select a program (e.g., Car Talk Program 3) for inclusion in the program schedule associated with the requesting station at the cart number specified. Other management options are possible including the deletion of program content from a program schedule using this interface. FIG. 4c shows a user interface presented to a user that specifies the requesting station's automation system is SS32. In this example interface, the user is able to additionally specify category information associated with a program item. The category information defines a file location for the content.

After accessing the content depot, and possibly defining one or more configurations, the user may locate (430) and request desired content (440). As part of the content request, non-radio information can be provided to the content depot to assist in the delivery of the content to the requesting station. In some implementations, the request for content can include a purchase. That is, the content depot can include content that is freely accessible and other content that is available for sale or based on a subscription basis. Accordingly, as part of the request process, the user can select the desired content, and may consummate a purchase arrangement. Through the purchase, the user can be granted limited or unfettered access to the content.

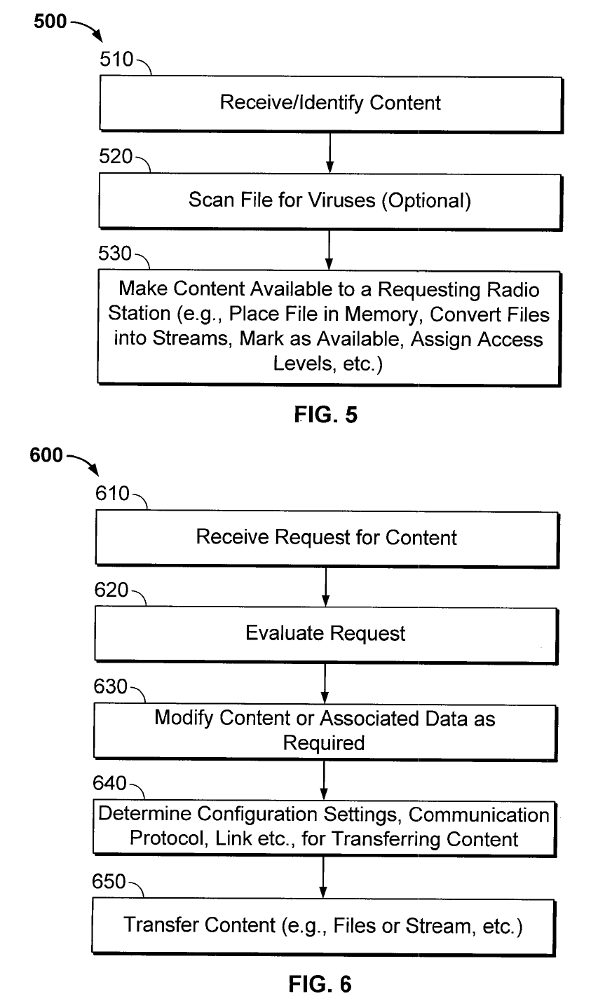

Referring now to FIG. 5, a method 500 for managing content that is included in the content depot is shown. In some implementations, the content depot may receive transferred content (510). For example, to market their information via the content depot, marketers and advertisers may transfer content into the content depot. In some embodiments, the content depot may optionally scan the transferred content for viruses (520).

In other implementations, the content depot may store the transferred content, and, upon purchase/selection by a user, make the content accessible to the purchasing user. In one embodiment, a user may “subscribe” to certain types of content available at the content depot, and may receive only the content of interest based on that user's subscription. For example, a purchasing user may be granted a certain set of permissions to use the content depot, and thereby may be given access to only certain content, or certain types of content. Having certain permissions at the content depot may allow for exchanges of content with other like-permissioned users. As such, radio content may be posted, with access to that content granted to preselected categories of users upon the posting of the content.

The content depot may then make the uploaded file available for transfer to a requesting user (530). Making the uploaded file available for transfer may be performed, for example, by placing the file into the content depot memory, by converting the file into a stream, by marking the file as available, or by assigning the file to a category with a specific level of access.

Referring now to FIG. 6, a method for distributing content 600 is shown. The method begins with the receipt of a request for content (610), such as at the content depot 110. The request can be evaluated to determine the requested content (620) along with requesting station particulars (e.g., non-radio data can be evaluated). The requested content can optionally be modify as necessary (630). For example, the content depot 110 may perform necessary conversions, like header conversions, of the requested content. In some implementations, these header conversions are based either on configurations included in the user profile, or from non-radio content included in the requesting station request,—e.g., automation system information for the requesting station.

After making any necessary modifications to the requested content, a determination is made as to a configuration settings, communication protocol, and/or link, to use for the transfer (640). For example, the content depot may determine to use a COM port associated with a radio automation system of a requesting station. Configuration information can be supplied with a request or stored in a profile associated with the requesting station and retrieved prior to the transfer. Pre-processing can include writing a correct header to transfer the desired content, in a desired slot, at the requesting station.

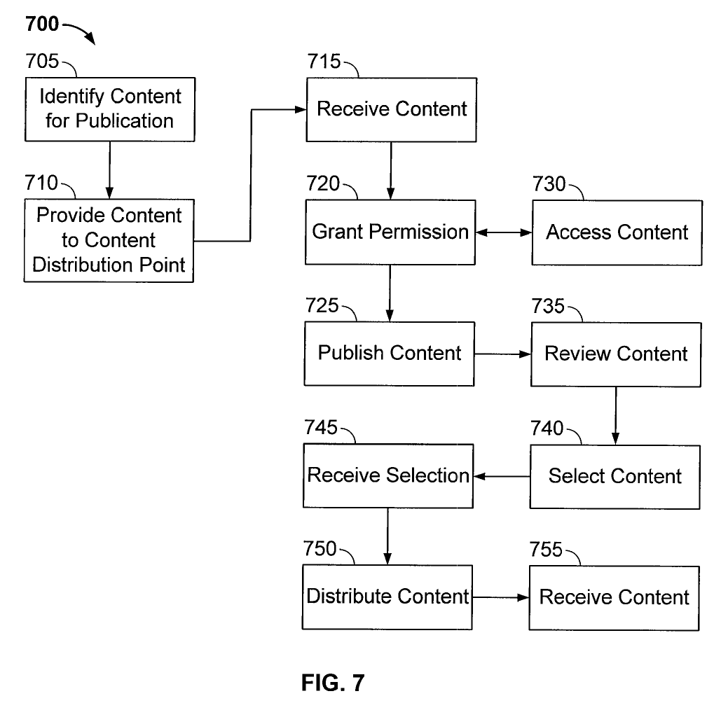

FIG. 7 illustrates an exemplary process for distributing content 700, starting with identifying content for publication, and ending with the selector/purchaser receiving the content.

Content for publication is identified, by for example a marketer (705). The identified content then is provided to a central distribution point (e.g., the content depot) (710).

The central distribution point receives the content (715), and in some implementations scans the content for viruses. In some implementations, the central distribution point determines whether to grant the content provider (e.g., marketer) permission (720) to publish the content. For example, the content provider may be required to provide feedback to the central distribution point of performance data associated with content that is selected (730). If permission is granted, the central distribution point publishes the content (725).

The published content may be accessible and retrievable by a purchaser/selector (735). For example, the purchaser may first accesses the central distribution point. If the purchaser obtains permission from the central distribution point, for example, via a web portal, the purchaser may review the accessible and published content. Next, the purchaser/selector may select content to receive (740). Upon receiving the purchaser's selection of content (745), the central distribution point may distribute the content to the requesting user including distributing the content in accordance with configuration information associated with the receiving user (750). The process ends with the purchaser/selector receiving the selected content (755).

A number of embodiments of the invention have been described. Nevertheless, it will be understood that various modifications may be made without departing from the spirit and scope of the invention. For example, predominant use of IP based networking could substitute for direct system connections via COM interface. Accordingly, other embodiments are within the scope of the following claims.

1. A method comprising:
centrally storing content for distribution to one or more radio stations;
receiving a request for a content item from a requesting radio station;
evaluating the request to determine if the requesting radio station is authorized to receive the content item;
if so, providing the content item including converting one or more headers associated with the content item based on data associated with the requesting radio station.

2. The method of claim 1 wherein centrally storing content includes storing content in a hub.

3. The method of claim 1 wherein the content is radio content.

4. The method of claim 1 wherein the content is selected from the group of a pre-recorded program and a streaming program.

5. The method of claim 1 wherein the content is selected from the group of program content and traffic.

6. The method of claim 5 wherein the traffic comprises one or more advertisement.

7. The method of claim 1 wherein receiving a request includes receiving login information from a user associated with the requesting radio station.

8. The method of claim 1 wherein providing the content item includes converting a header associated with the content item.

9. The method of claim 1 wherein centrally storing content further includes aggregating content from plural sources.

10. The method of claim 1 wherein providing the content item includes determining an automation system type associated with the requesting radio station, and pre-processing the content item in accordance with the automation system type.

11. The method of claim 10 wherein pre-processing includes converting a header associated with the content item.

12. The method of claim 10 wherein pre-processing includes converting a cart header associated with the content item to a cart header associated with the automation system type.

13. The method of claim 12 further comprising determining if the automation system type is SS32, and if so, then pre-processing the content item includes converting a cart header associated with the content item to a SS32 type cart header.

14. The method of claim 13 wherein pre-processing further comprises calculating a duration of audio associated with the content item and updating the content item header.

15. The method of claim 13 wherein pre-processing further comprises receiving a path definition that includes a digital system audio path, cart number and a category, constructing a path using the digital audio path and the category, and saving a file associated with the content item in the path with the cart number specified.

16. The method of claim 12 further comprising determining if the automation system is Maestro, and if so, then pre-processing the content item includes converting a cart header associated with the content item to a DAF type cart header.

17. The method of claim 16 wherein pre-processing further comprises receiving a path definition that includes a digital system audio path and cart number, and saving a file associated with the content item in the digital audio system path with the cart number specified.

18. A method comprising
identifying content from plural sources for publication by one or more radio stations;
aggregating the identified content in a central repository;
controlling access to the aggregated content;
receiving requests to access the identified content;
identifying transfer controls associated with the publication of the accessed content; and
transferring, in accordance with the transfer controls, content associated with requests upon verification of credentials associated with a requesting device.

19. A method comprising:
aggregating content;
marketing the content for distribution to one or more radio stations;
receiving a selection of a content item;
pre-processing the selected item in accordance with system parameters associated with a requesting system; and
delivering the pre-processed item to the requesting system.

20. An apparatus comprising:
a hub including
a content depot, the content depot including designators for one or more content items that are available to authorized radio stations for play on the radio station;
an interface communicatively coupled between the content depot and one or more radio stations;
a user interface for managing content in the content depot including the inclusion of content in the depot by content providers and the selection of content by a radio station for inclusion in a playlist associated with the radio station; and
a conversion engine operable to convert a content item or metadata associated with a content item in accordance with parameters associated with a requesting radio station wherein at least one parameter is an automation system type of a requesting radio station.
